(19) United States
(12) Patent Application Publication
(10) Pub. No.: US 2016/0278581 A1
(43) Pub. Date: Sep. 29, 2016

(54) MULTILAYER STRUCTURE

(71) Applicant: DOW GLOBAL TECHNOLOGIES LLC, Midland, MI (US)

(72) Inventors: Swapnil S. Chandak, Pearland, TX (US); Jason C. Brodil, Rosharon, TX (US)

(21) Appl. No.: 15/034,695

(22) PCT Filed: Oct. 30, 2014
(86) PCT No.: PCT/US2014/063177

§ 371 Date: May 5, 2016

Related U.S. Application Data
(60) Provisional application No. 61/903,074, filed on Nov. 12, 2013.

(51) Int. Cl. A47J 47/00; B32B 27/32

(52) U.S. Cl. CPC A47J 47/005; B32B 27/32; B32B 2307/744; B32B 2307/581; B32B 2307/726

(57) ABSTRACT

The instant invention provides a multilayer structure. The multilayer structure according to the present invention comprises: at least a first layer comprising a high-density polyethylene composition having a density in the range of from 0.936 to 0.965 g/cm³, a melt index (I₂) in the range of from 0.05 to 1.0 g/10 minutes, wherein the first layer has a thickness in the range of from 4 to 10 mil; at least a second layer comprising an adhesive composition; and at least a third layer comprising an absorbent material, wherein the second layer is disposed between the first layer and the third layer.

### FIELD OF INVENTION

The instant invention relates to a multilayer structure, e.g. a cutting board.

### BACKGROUND OF THE INVENTION

Sheet-like materials for use in protecting objects or substances from a supporting surface, and/or protecting supporting surfaces from objects or substances, are well known in the art. Such materials can be utilized to provide a permanent form of protection, but frequently are situation or task-oriented and are only required or utilized for a limited period of time. One common scenario for the use of such sheet materials is the preparation of food items for consumption, such as the preparing of certain meat products for cooking. Protective sheet materials in such a scenario may provide dual protective functions in protecting the food item from soiling and other contamination from a supporting surface, such as a countertop, as well as protecting the supporting surface from soiling due to blood, water, and other fluids and substances present on the surface of the food item. Protective sheet materials may also protect a supporting surface from physical damage such as impact from a sharp object or cutting device such as a knife or cleaver used in such food preparation.

Typically, the consumer is faced with a paradox in selecting an appropriate sheet material for use in such a food preparation scenario. Sheet materials which are comparatively high in absorbency, such as paper-based materials, are typically low in cut resistance, while those which are comparatively high in cut-resistance, such as plastic sheet materials, are comparatively low in absorbency. Another disadvantage of sheet materials that are comparatively high in absorbency is that they are difficult to sanitize after use to prevent contamination of subsequent food materials that contact the sheet material. This can be due in part to cuts being made in the sheet material that cannot be readily cleaned because of the absorbent nature of the sheet material.

Accordingly, there is a need for a multilayer structure having improved absorbency properties as well as cut resistance properties.

### SUMMARY OF THE INVENTION

The instant invention provides a multilayer structure. The multilayer structure according to the present invention comprises: (a) at least one first layer comprising a high-density polyethylene composition having a density in the range of 0.936 to 0.965 g/cm³, a melt index (I₂) in the range of 0.05 to 1.0 g/10 minutes, wherein each one or more first layer has a thickness in the range of from 4 to 10 mil; (b) at least one second layer comprising an adhesive composition; and (c) at least one third layer comprising an absorbent material, wherein the second layer is disposed between the first layer and the third layer.

In an alternative embodiment, the instant invention provides a multilayer structure, in accordance with any of the preceding embodiments, except that the multilayer structure further comprises a fourth layer comprising a slip resistance layer and optionally a sealant layer.

In an alternative embodiment, the instant invention provides a multilayer structure, in accordance with any of the preceding embodiments, except that the multilayer structure has a cut resistance of at least 3.

In an alternative embodiment, the instant invention provides a multilayer structure, in accordance with any of the preceding embodiments, except that the multilayer structure has a load of at least 1000 g.

In an alternative embodiment, the instant invention provides a multilayer structure, in accordance with any of the preceding embodiments, except that the multilayer structure is used as a surface protector.

In an alternative embodiment, the instant invention provides a multilayer structure, in accordance with any of the preceding embodiments, except that the multilayer structure is a counter top or a cutting board.

In an alternative embodiment, the instant invention provides a multilayer structure, in accordance with any of the preceding embodiments, except that the multilayer structure is formed via lamination process, or extrusion coating process.

### DETAILED DESCRIPTION OF THE INVENTION

The instant invention provides a multilayer structure, e.g. a cutting board. The multilayer structure according to the present invention comprises: at least a first layer comprising a high-density polyethylene composition having a density in the range of from 0.936 to 0.965 g/cm³, a melt index (I₂) in the range of from 0.05 to 1.0 g/10 minutes, wherein the first layer has a thickness in the range of from 4 to 10 mil; at least a second layer comprising an adhesive composition; and at least a third layer comprising an absorbent material, wherein the second layer is disposed between the first layer and the third layer.

### First Layer

The multilayer structure comprises from 10 to 70 percent by thickness of the first layer, for example, from 10 to 60 percent by thickness of the first layer, or in the alternative, from 10 to 50 percent by thickness of the first layer. The first layer has a thickness in the range of from 4 to 10 mils, for example, from 4 to 6 mils; or in the alternative, from 4 to 8 mils.

The first layer comprises a high-density polyethylene composition having a density in the range of 0.936 to 0.965 g/cm³, for example, from 0.948 to 0.965 g/cm³, from 0.952 to 0.965 g/cm³; or in the alternative, from 0.955 to 0.965 g/cm³; or in another alternative, from 0.960 to 0.965 g/cm³. The first layer comprises a high-density polyethylene composition having a melt index (I₂) in the range of from 0.05 to 1.0 g/10 minutes, for example, from 0.05 to 0.5 g/10 minutes; or in the alternative, from 0.05 to 0.8 g/10 minutes; or in another alternative, from 0.05 to 0.1 g/10 minutes.

The high-density polyethylene composition comprises (a) less than or equal to 100 percent, for example, at least 70 percent, or at least 80 percent, or at least 90 percent, by weight of units derived from ethylene; and (b) less than 30 percent, for example, less than 25 percent, or less than 20 percent, or less than 10 percent, by weight of units derived from one or more α-olefin comonomers. The term “high-density polyethylene composition” refers to a polymer that contains more than 50 mole percent polymerized ethylene monomer (based on the total amount of polymerizable monomers) and, optionally, may contain at least one comonomer.

The α-olefin comonomers typically have no more than 20 carbon atoms. For example, the α-olefin comonomers may preferably have 3 to 10 carbon atoms, and more preferably 3 to 8 carbon atoms. Exemplary α-olefin comonomers include, but are not limited to, propylene, 1-butene, 1-pentene, 1-hexene, 1-heptene, 1-octene, 1-nonene, 1-decene, and 4-methyl-l-pentene. The one or more α-olefin comonomers may, for example, be selected from the group consisting of propylene, 1-butene, 1-hexene, and 1-octene; or in the alternative, from the group consisting of 1-hexene and 1-octene.

The high-density polyethylene composition may further comprise additional components such as one or more other polymers and/or one or more additives. Such additives include, but are not limited to, antistatic agents, color enhancers, dyes, lubricants, fillers such as TiO₂ or CaCO₃, opacifiers, nucleators, processing aids, pigments, primary antioxidants, secondary antioxidants, processing aids, UV stabilizers, anti-blocks, slip agents, tackifiers, fire retardants, anti-microbial agents, odor reducer agents, anti fungal agents, and combinations thereof. The high-density polyethylene composition may contain from about 0.1 to about 10 percent by the combined weight of such additives, based on the weight of the high-density polyethylene composition including such additives.

Any conventional ethylene (co)polymerization reaction processes may be employed to produce the high-density polyethylene composition. Such conventional ethylene (co)polymerization reaction processes include, but are not limited to, solution phase polymerization process, or any particle forming process, using one or more conventional reactors, e.g. loop reactors, stirred tank reactors, batch reactors in parallel, series, and/or any combinations thereof.

Such high-density polyethylene compositions are commercially available under the tradename ELITE™, CONTINUUM™, TUFLIN™ or UNIVAL™ from The Dow Chemical Company.

### Second Layer

The multilayer structure comprises from 5 to 50 percent by thickness of the second layer, for example, from 10 to 40 percent by thickness of the second layer, or in the alternative, from 10 to 30 percent by thickness of the second layer. The second layer has a thickness in the range of from 0.25 to 2 mils, for example, from 0.25 to 1.5 mils; or in the alternative, from 0.25 to 1 mils.

The second layer comprises an adhesive composition. Such adhesive compositions include, but are not limited, polyolefin based adhesive compositions, acrylate based adhesive compositions, epoxy based adhesive compositions and/or polyurethane based adhesives. Exemplary polyolefin compositions include, but are not limited to, polyethylene and/or polypropylene. Such adhesive compositions can be pressure sensitive adhesives, hot melt adhesives, and/or heat activated adhesives. Such adhesive compositions can include aqueous based dispersions, polyolefin based dispersions and/or polyurethane based dispersions.

The adhesive composition may further comprise additional components such as one or more other polymers and/or one or more additives. Such additives include, but are not limited to, antistatic agents, color enhancers, dyes, lubricants, fillers such as TiO₂ or CaCO₃, opacifiers, nucleators, processing aids, pigments, primary antioxidants, secondary antioxidants, UV stabilizers, anti-blocks, slip agents, tackifiers, fire retardants, anti-microbial agents, odor reducer agents, anti fungal agents, and combinations thereof. The adhesive composition may contain from about 0.1 to about 10 percent by the combined weight of such additives, based on the weight of the adhesive composition including such additives.

### Third Layer

The multilayer structure comprises from 10 to 70 percent by thickness of the third layer, for example, from 10 to 60 percent by thickness of the third layer, or in the alternative, from 10 to 50 percent by thickness of the third layer. The third layer has a thickness in the range of from 4 to 10 mils, for example, from 4 to 6 mils; or in the alternative, from 4 to 8 mils.

The third layer comprises an absorbent material. Such absorbent materials include, but are not limited to, cotton based materials, cellulosic based materials such as paper, cardboard, and/or non-woven materials such as polypropylene non-wovens, and/or polyester non-wovens.

### Additional Layers

The multilayer structure can further comprise a fourth layer comprising a slip resistance layer and optionally a sealant layer.

The multilayer structure comprises from 5 to 70 percent by thickness of the fourth layer, for example, from 5 to 60 percent by thickness of the fourth layer, or in the alternative, from 5 to 50 percent by thickness of the fourth layer. The fourth layer has a thickness in the range of from 1 to 10 mils, for example, from 1 to 6 mils; or in the alternative, from 1 to 8 mils.

The slip resistance layer comprises a polyolefin composition such as polyethylene and/or polypropylene.

Such polyethylene compositions have a density in the range of 0.890 to 0.945 g/cm³, for example, from 0.890 to 0.940 g/cm³; or in the alternative, from 0.895 to 0.940 g/cm³; or in another alternative, from 0.895 to 0.935 g/cm³. Such polyethylene compositions can have a melt index (I₂) in the range of from 0.05 to 10.0 g/10 minutes, for example, from 0.05 to 8 g/10 minutes; or in the alternative, from 0.05 to 5 g/10 minutes; or in another alternative, from 0.05 to 4 g/10 minutes.

Such polypropylene compositions can have a melt flow rate in the rage of from 0.05 to 25 g/10 minutes, for example, from 0.05 to 20 g/10 minutes; or in the alternative, from 0.05 to 15 g/10 minutes; or in another alternative, from 0.05 to 12 g/10 minutes.

The polyolefin compositions suitable for the slip resistance layer can further comprise additional components such as one or more other polymers and/or one or more additives. Such additives include, but are not limited to, antistatic agents, color enhancers, dyes, lubricants, fillers such as TiO₂ or CaCO₃, opacifiers, nucleators, processing aids, pigments, primary antioxidants, secondary antioxidants, UV stabilizers, anti-blocks, slip agents, tackifiers, fire retardants, anti-microbial agents, odor reducer agents, anti fungal agents, and combinations thereof. The polyolefin composition may contain from about 0.1 to about 10 percent by the combined weight of such additives, based on the weight of the polyolefin composition including such additives.

Such polyethylene compositions are commercially available under the tradename TUFLIN™, ELITE™, ATTANE™, and/or AFFINITY™ from The Dow Chemical Company.

Such polypropylene compositions are commercially available under the tradename VERSIFY™ from The Dow Chemical Company.

The multilayer structure can have a cut resistance of at least 3, and/or a load of at least 1000 g. The multilayer structure can be used as a surface protector, for example, the multilayer structure can be used as a cutting board. The multilayer structure can be prepared via any method. For example the multilayer structure according to the present invention can be formed via extrusion coating process, extrusion lamination process, and cast film extrusion process.

In the extrusion coating process, the polymeric composition is melted via, for example an extruder, and the molten polymeric composition is applied to a moving substrate such as paper, paperboard; thereby, producing a coated substrate or multilayer structure.

In the extrusion lamination process, the polymeric material is melted via, for example an extruder, and the molten polymer composition is applied to at least 2 moving substrates to be glued together with the molten polymer composition.

In both extrusion coating and extrusion lamination processes, the traveling substrate(s) is (are) being pressed between a pressure loaded roll and a chill roll for quick quenching of the molten polymer composition.

In the cast film extrusion process, a thin film is extruded through a slit onto a chilled, highly polished turning roll, where it is quenched from one side. The speed of the roller controls the draw ratio and final film thickness. The film is then sent to a second roller for cooling on the other side. Finally it passes through a system of rollers and is wound onto a roll. The process is complemented with lamination process; thus, forming a multilayer structure.

### EXAMPLES

The following examples illustrate the present invention but are not intended to limit the scope of the invention. The examples of the instant invention demonstrate that the multilayer structures have improved cut resistance properties.

### Formulation Components

CONTINUUM™ DMDA-6620 NT (HDPE-1) is a bimodal high-density polyethylene having a density of approximately 0.958 g/cm³, measured according to ASTM D792, and a melt index (I₂) of approximately 0.28 g/10 minutes, measured according to ASTM D1238.

DOW™ HDPE DGDC-2100 NT 7 (HDPE-2) is a high-density polyethylene having a density of approximately 0.948 g/cm³, measured according to ASTM D792, and a melt index (I₂) of approximately 0.07 g/10 minutes, measured according to ASTM D1238.

DOW™ HDPE DGDP-6097 NT 7 (HDPE-3) is a high-density polyethylene having a density of approximately 0.948 g/cm³, measured according to ASTM D792, and a melt index (I₂) of approximately less than 1 g/10 minutes, measured according to ASTM D1238.

ELITE™ 5960G (HDPE-4) is a high-density polyethylene having a density of approximately 0.962 g/cm³, measured according to ASTM D792, and a melt index (I₂) of approximately 0.85 g/10 minutes, measured according to ASTM D1238.

UNIVAL™ DMDA-6400 NT 7 (HDPE-5) is a high-density polyethylene having a density of approximately 0.961 g/cm³, measured according to ASTM D792, and a melt index (I₂) of approximately 0.80 g/10 minutes, measured according to ASTM D1238.

XHS-7071 NT 7 (MDPE-1) is a fractional melt index medium density polyethylene having a density of approximately 0.936 g/cm³, measured according to ASTM D792, and a melt index (I₂) of approximately 0.32 g/10 minutes, measured according to ASTM D1238.

Inventive multilayer structures 1-6 (IMS 1-6) comprising a first layer, a second layer, and a third layer were prepared according to the following process.

### First Layers 1-12

First layers 1-12 (FL 1-12) are films prepared based on the formulation components and extrusion process conditions reported in Table 2, via a 25 mm Haake Counter rotating Twin screw extruder attached with a six inch wide sheet die and a take-off system, as further described in Table 1 below, that is positioned close to the extruder die so that the melt immediately flows on the surface of the temperature controlled chill rolls and is forced through the gap in between the upper and the center roll.

TABLE 1

| Chill Roller Block | | | Pull Roller Block | |
|---|---|---|---|---|
| Driven | 3 | | Driven Rollers | 3 |
| Rollers | | | | |
| Diameter | 75 | mm | Diameter | Liquid |
| Width | 250 | mm | Width | 75 mm |

| | | | |
|---|---|---|---|
| Material | Stainless Steel V4A | Surface Finish | Rubber |
| Number of | 3 | Roller Gap | Adjustable |
| Temperature | | | |
| Controlled | | | |
| Rollers | | | |
| Heat | Liquid | Take off Speed | 0-9.8 m/min |
| Transfer | | | in both |
| Medium | | | direction |

| | | |
|---|---|---|
| Max. Temp | 200 | degree C. |

TABLE 2

| | Film | | | Screw | Extrusion | Feeder | Chill | Take |
|---|---|---|---|---|---|---|---|---|
| | Thickness | | | speed | Temp | Speed | Roll | Off |
| | (mil) | Material | Torque | (rpm) | (C. °) | (rpm) | (F. °) | Speed |
| FL-1 | 6 | HDPE-4 | 19,800 | 100 | 220 | 200 | 170 | 380 |
| FL-2 | 4 | HDPE-4 | 19,700 | 100 | 220 | 200 | 170 | 520 |
| FL-3 | 6 | HDPE-1 | 21,000 | 100 | 220 | 200 | 170 | 385 |
| FL-4 | 4 | HDPE-1 | 20,000 | 100 | 220 | 200 | 170 | 575 |
| FL-5 | 6 | HDPE-2 | 25,300 | 100 | 220 | 200 | 170 | 375 |
| FL-6 | 4 | HDPE-2 | 25,700 | 100 | 210 | 200 | 170 | 450 |
| FL-7 | 6 | HDPE-3 | 25,300 | 100 | 220 | 200 | 170 | 375 |
| FL-8 | 4 | HDPE-3 | 25,100 | 100 | 220 | 200 | 170 | 500 |
| FL-9 | 4 | MDPE-1 | 24,000 | 100 | 220 | 200 | 170 | 410 |
| FL-10 | 6 | MDPE-1 | 24,000 | 100 | 220 | 200 | 170 | n/a |
| FL-11 | 4 | HDPE-5 | 25,100 | 100 | 220 | 200 | 170 | 515 |
| FL-12 | 6 | HDPE-5 | 25,100 | 100 | 220 | 200 | 170 | 720 |

### Second Layer 1

Second layer 1 comprising an adhesive composition is a 3M™ 950 Adhesive Transfer Tape with 3M™ Adhesive 300 (having tape thickness of approximately 5 mil).

### Third Layer 1

Third layer 1 (comprising an absorbent material) is an all purpose white wipe commercially available under the trade name WypAll L40 from Kimberly-Clark Corporation.

### Inventive Multilayer Structures 1-6

Inventive multilayer structures 1-6 (IMS 1-6) were prepared via a lamination process to form a multilayer structure comprising a first layer, a second layer and a third layer as described above. The second layer and the third layer are the same for each IMS 1-6, and first layer (Film layers having 6 mil) for each IMS 1-6 is reported in Table 3. Each IMS 1-6 was tested for its cut resistance properties per ASTM F1790 Standard Test Method for Measuring Cut Resistance of Materials Used in Protective Clothing 2005 Edition, and the results are reported in Table 3.

TABLE 3

| | | ANSI/ISEA Classification for | |
|---|---|---|---|
| | First Layer | Cut Resistance | Load (grams) |
| IMLS-1 | FL-3 | 3 | 1341 |
| IMLS-2 | FL-10 | 2 | 835 |
| IMLS-3 | FL-1 | 3 | 1046 |
| IMLS-4 | FL-12 | 3 | 1431 |
| IMLS-5 | FL-5 | 2 | 949 |
| IMLS-6 | FL-7 | 2 | 984 |

Comparative multilayer structure 1 is a commercially available product comprising (a) a first layer comprising polypropylene, and (b) a cellulosic absorbent having ANSI/ISEA Classification for cut resistance of 3, and a Load of 1078 grams.

### Test Methods

Test methods include the following:

### Melt Index

Melt index I₂ is measured in accordance to ASTM D-1238 at 190° C. and at 2.16 kg load, and reported in g/10 min.

### Melt Flow Rate

Melt flow rate is measured in accordance to ASTM D-1238 at 230° C. and at 2.16 kg load, and reported in g/10 min.

### Density

Samples for density measurement were prepared according to ASTM D4703. Measurements were made within one hour of sample pressing using ASTM D792, Method B, and reported in g/cm³.

Cut resistance of the samples was tested as per the ASTM F 1790-05 which assesses the cut resistance of a material when exposed to a cutting edge under specified loads. This test method establishes the different loads that various materials can carry to a fixed distance. Materials are capable of delivering better cut resistance if they can:

1. Provide higher cut resistance by demonstrating a longer distance traveled when equal loads are mounted

2. Provide higher cut resistance by demonstrating resistance to higher loads at the same distance traversed.

### Summary of the Test Procedure:

A 2 inch by 4 inch test specimen is cut at random from the sample and mounted on the calibrated apparatus as described in the ASTM F 1790-05 procedure.

A cutting edge with a specified load is moved one time across a specimen mounted on the apparatus.

The distance is recorded, form the initial contact to cut through for each load.

A series of tests are performed to establish the range and to determine the Force (N) or Rating Force (grams) and then the results are normalized.

The resulting load versus distance curve can be used to determine the cut resistance of the specimen.

At very small loads, infinite distances are anticipated and while heavier loads will generate distances approaching zero.

ANSI cut level was measured according to ANSI/ISEA 105, which is the standard that assigns “levels” according to the gram weight from ASTM Testing and utilizes BOTH 1790-07 AND 1790-05. The various levels are listed below, and reported in Normalized Load.
Level 0<200 grams
Level 1>200 to 500 grams
Level 2>500 to 1000 grams
Level 3>1000 to 1500 grams
Level 4>1500 to 3500 grams
Level 5>3500 grams

The present invention may be embodied in other forms without departing from the spirit and the essential attributes thereof, and, accordingly, reference should be made to the appended claims, rather than to the foregoing specification, as indicating the scope of the invention.

We claim:

1. A multilayer structure comprising:
a. a first layer comprising a polyethylene composition having a density in the range of 0.936 to 0.965 g/cm³, a melt index (I₂) in the range of 0.05 to 1.0 g/10 minutes, wherein said first layer has a thickness in the range of from 4 to 10 mil;
b. a second layer comprising an adhesive composition;
c. a third layer comprising an absorbent material;
wherein said second layer is disposed between said first layer and said third layer.

2. The multilayer structure of claim 1, wherein said multilayer structure further comprises a fourth layer comprising a slip resistance layer and optionally a sealant layer.

3. The multilayer structure of claim 1, wherein said multilayer structure has a cut resistance of at least 2.

4. The multilayer structure of claim 1, wherein said multilayer structure has a load of at least 1000 g.

5. The multilayer structure of claim 1, wherein said multilayer structure is a surface protector.

6. The multilayer structure of claim 1, wherein said multilayer structure is a cutting board.

7. The multilayer structure of claim 1, wherein said multilayer structure is formed via lamination process, or extrusion coating process.

8. The multilayer structure of claim 1, wherein said first layer is perforated.

9. The multilayer structure of claim 1 or claim 8, wherein said second layer is perforated.

10. The multilayer structure of claim 1, wherein said multilayer structure has a cut resistance of at least 3.
